(19) United States
(12) Patent Application Publication
(10) Pub. No.: US 2013/0048673 A1
(43) Pub. Date: Feb. 28, 2013

(54) SELECTIVE DISPENSING FROM ONE OR MORE CONTAINER RECEPTACLES

(71) Applicant: Steve Niemis, Jupiter, FL (US)

(72) Inventor: Steve Niemis, Jupiter, FL (US)

(21) Appl. No.: 13/216,094

(22) Filed: Aug. 23, 2011

(51) Int. Cl. B67D 7/36

(52) U.S. Cl. 222/144.5; 222/129

(57) ABSTRACT

A closure for pouring selectively from one or both of two pour orifices of one or more fluid containers. The closure yokes the fluid containers together where more than one fluid container is provided. Alternatively, the closure may work with a single container incorporating plural fluid compartments. The closure may incorporate a movable valve and sufficient passages to enable fluids to be poured from a selected one pour orifice or from plural pour orifices, with proportions of the two fluids being selectable. The closure may incorporate a pouring spout to guide fluids being poured. The valve may be rotary or linearly acting, and have a manual operator.

### FIELD OF THE INVENTION

The present invention relates to fluid containers, and more particularly to dispensing from one or more container receptacles either individually or simultaneously.

### BACKGROUND OF THE INVENTION

Liquids such as beverages may be distributed at the retail level in containers of capacity generally intended for consumption of the entire contents at once. However, consumer apetites differ, so that the “one size fits all” philosophy will not apply in some cases. Particularly in light of a historical trend of increasing retail portion size, a consumer may want to consume only part of the entire contents of a retail container. In the case of many beverages, this introduces the problem that the unused portion of the product will be susceptible to degradation. Exposure to ambient air, release of pressure, and other factors may degrade characteristics of the beverage in the eyes of the consumer. Therefore, even if the container is reclosable, it may be undesirable to open a container, consume part of the contents, and reclose the container.

Some beverages are consumed as combinations of two beverages. Examples include concentrates in liquid form and water, alcoholic beverages and flavoring beverages such as the long popular rum and Coca-Cola (®) or whiskey and Coca-Cola (®), coffee and milk or cream, tea and lemonade or other fruit based beverage, and still others. In the case of such binary beverages, the consensus opinion is that it is usually the case that the best beverages result when the two components are freshly mixed.

When a binary beverage is provided, there is also the possibility that the user will want only one of the two available beverages.

There exists a need for a container capable of storing two or more different liquids in a manner such that they remain separated from one another, and allowing for either or both to be dispensed at one time.

### SUMMARY OF THE INVENTION

The present invention provides a closure device for selectively opening and closing one or both of two container receptacles or orifices in a manner which enables a user to pour fluid contents from any selected one or both of the containers. The closure device may comprise a cap which closes and opens two compartments of a dual compartmented container, or alternatively, may span and yoke together two separate containers.

The closure device may incorporate a valve which may be moved to a first position wherein all container orifices are closed, to a second position wherein the orifice of a first container is open, to a third position wherein the orifice of the second container is open, and optionally to a fourth position in which both orifices of both containers are open.

The closure device may comprise pouring spouts to facilitate pouring from any open orifice.

The invention may be thought of as a way of storing and dispensing selectively one fluid or two fluids using only one receptacle or assembly of receptacles.

It is an object of the invention to provide a closure device which can selectively open or close a first orifice of a first fluid container, a second orifice of a second fluid container, or both the first and second orifices of both containers.

It is an object of the invention to provide improved elements and arrangements thereof by apparatus for the purposes described which is inexpensive, dependable, and fully effective in accomplishing its intended purposes.

These and other objects of the present invention will become readily apparent upon further review of the following specification and drawings.

### BRIEF DESCRIPTION OF THE DRAWINGS

Various objects, features, and attendant advantages of the present invention will become more fully appreciated as the same becomes better understood when considered in conjunction with the accompanying drawings, in which like reference characters designate the same or similar parts throughout the several views, and wherein:

FIG. 1 is a perspective view of two fluid containers and a closure device serving both of the containers, according to at least one aspect of the invention.

FIG. 2 is a side view of FIG. 1.

FIG. 3 is an exploded detail view of the closure device of FIG. 1.

FIG. 4 is a top perspective detail view of an alternative to the closure device of FIG. 1.

FIG. 5 is a top perspective detail view of another alternative to the closure device of FIG. 1.

FIG. 6 is a side view of two fluid containers and a different closure device serving the two fluid containers.

FIG. 7 is an enlarged top perspective detail view of the closure device of FIG. 7.

FIG. 8 is a side view of the closure device of FIG. 1, shown serving a dual compartment container.

FIG. 9 is a side perspective view of a dual compartment fluid container according to at least one aspect of the invention.

FIG. 10 is a side perspective view of another dual compartment fluid container according to at least one aspect of the invention.

### DETAILED DESCRIPTION

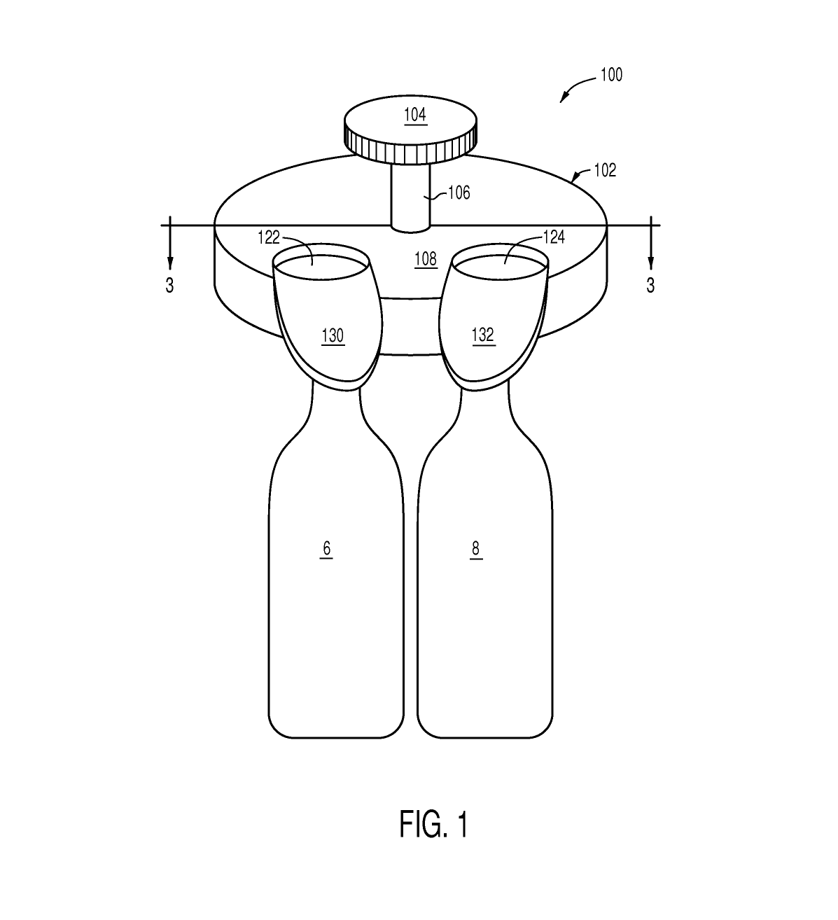

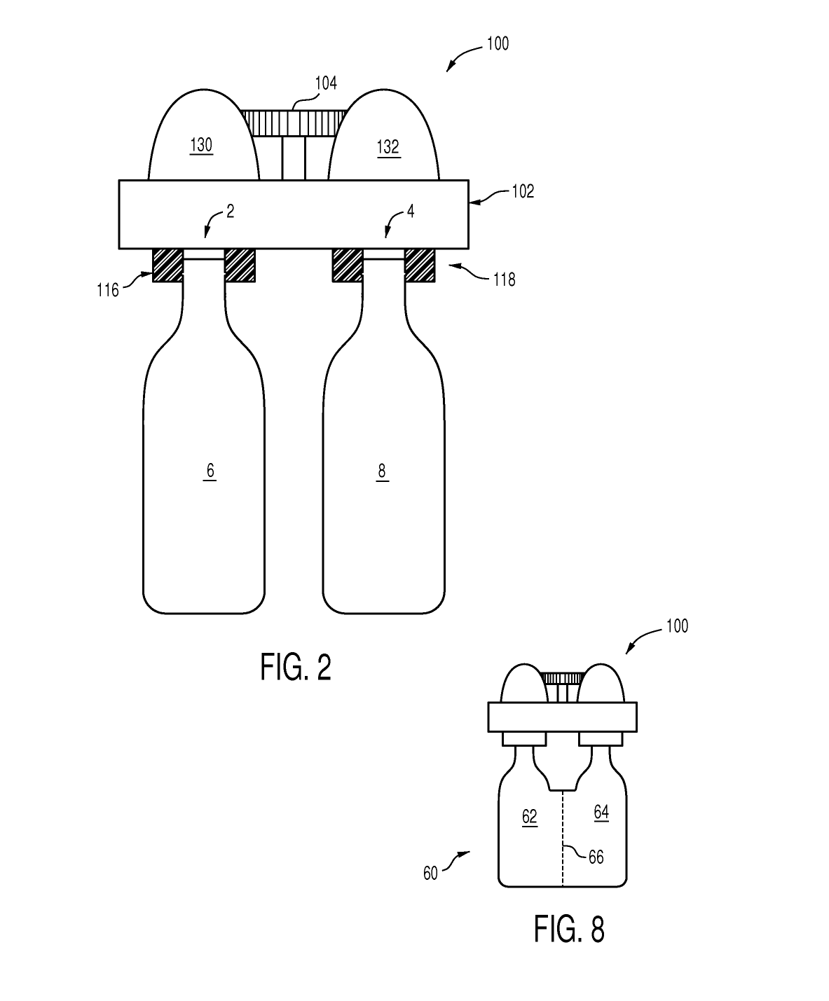

Referring first to FIGS. 1 and 2, according to at least one aspect of the invention, there is shown a closure device 100 for controlling a plurality of pour orifices 2, 4 (see FIG. 2) of two fluid containers 6, 8. The closure device 100 spans and yokes together the fluid containers 6, 8 as well as controlling the pour orifices 2, 4. As employed herein, controlling the pour orifices 2, 4 signifies that the closure device 100 serves as a valve which may selectively open and close the pour orifices 2, 4, and further may control the degree to which the pour orifices 2, 4 are opened. Furthermore, the pour orifices 2, 4 will be understood to signify not only the openings thereof, but also the solid or structural portions of the containers 6, 8 which define the actual openings or passageways of the pour orifices 2, 4.

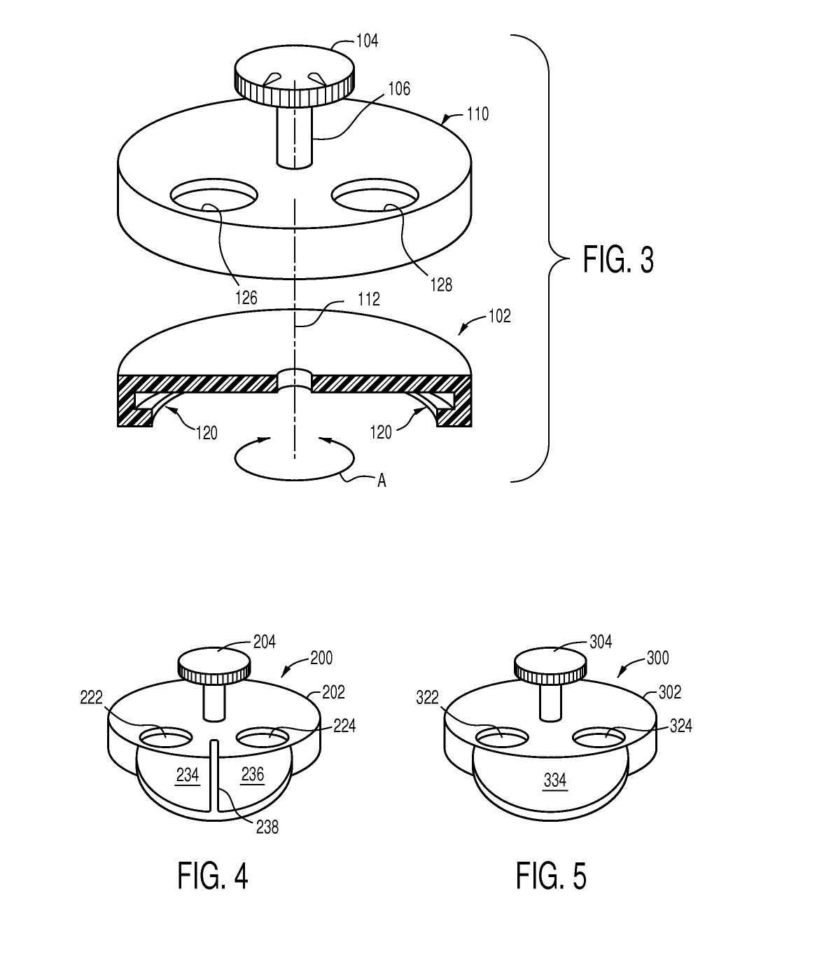

The closure device 100 may comprise a stationary structural member and a relatively movable valve structure. The valve of the valve structure is contained or housed within the structural member, which structural member will be called a housing 102. A valve operator in the form of a rotatable knob 104 which is accessible for manual manipulation from outside the housing 102, as may be seen in FIGS. 1 and 2. The rotatable knob 104 may have ridges as shown or other texturing (not shown) to enhance finger grip to facilitate operation of the valve. Referring also to FIG. 3, the rotatable knob 104 may have a shaft 106 which passes through an opening 114 formed in the upper wall 108 of the housing 102 to engage and rotate a valve 110 about an axis of rotation 112. Rotation of the valve 110 is indicated by an arrow A in FIG. 3.

Clearly visible in FIG. 3, the housing 100 has a first engagement structure disposed to engage and hold the small end of the container 6 which terminates at the pour orifice 2 and a second engagement structure disposed to engage and hold the small end of the container 8 which terminates at the pour orifice 4. The first and second engagement structures may comprise sockets 116, 118 each of which resilient grips a respect pour orifice 2 or 4. The sockets 116, 118 may be molded integrally with the housing 102 or alternatively, may be formed separately and subsequently joined to the housing 102. The sockets 116, 118 may engage the pour orifices 2, 4 by resilient contraction thereabout (as shown), by threading (not shown), by bayonet connection (not shown), by snap fit (not shown), or in any other suitable way. The sockets 116, 118 may be manually removable from the housing 102 such as by threading if desired (this option is not shown).

The housing 102 defines passages 122, 124 which enable contents of each container 6 or 8 to be accessible or to be sealed from the environment. A valve assembly is disposed to open and close each of the pour orifices 2 or 4 selectively individually and collectively. As seen in FIG. 3, the valve assembly comprises a rotary valve 110 secured to the housing 102. The rotary valve 110 may be secured by entrapment and close fit within the housing 102. A groove 120 is formed inside the housing 102 to receive the rotary valve 110 and hold the rotary valve 110 in various positions as the latter reveals and obstructs the fluid passages 122, 124 formed in the housing 102. The groove 120 may extend entirely about the circumference of the housing 102 to enable the valve 110 to be rotated continuously. The fluid passages 122, 124 are located above the pour orifices 2, 4. As employed herein, the valve assembly will be understood to encompass the valve 110, the housing 102 and especially the features of the latter which define flow passages enabling fluids to be poured from the containers 6 and 8 when the valve 110 is in any one of several open positions, and the valve operator 104, and all other structure necessary for successful valve operation as described herein.

When the valve 110 is rotated such that an opening 126 formed therein is aligned with the fluid passage 124 and with another opening 128 located out of alignment with the fluid passage 122, fluid contents may flow or be poured from the fluid container 8. When the opening 128 is aligned with the fluid passage 122, fluid contents may be poured from the fluid container 6. When the openings 126, 128 are aligned respectively with the fluid passages 122, 124, fluids may be poured simultaneously from both fluid containers 6 and 8. Fine adjustment of the valve 110 may be made to modify the degree of opening of the fluid passages 122, 124 when it is desired to have unequal flow from the fluid containers 6, 8. Therefore, the valve assembly is disposed to selectively open the first passage 122, the second passage 124, or both the first passage 122 and the second passage 124 simultaneously.

Referring to FIGS. 1 and 2, the housing 102 may comprise a first pour spout 130 disposed to direct fluid being poured from the pour orifice 2 and a second pour spout 132 disposed to direct fluid being poured from the pour orifice 4. Of course, the pour spout feature may be arranged in other ways. For example, and referring to FIG. 4, pour spouts 234, 236 may be siamesed, being joined at a common wall 238 which separates flows of fluid along the length of the two pour spouts 234, 236. The pour spouts 234, 236 may be located in alignment with passages 222, 224 which may be formed as part of a closure device 200 which, apart from the details of the siamesed pour spouts 234, 236, may be the structural and functional equivalent of the closure device 100 of FIG. 1.

In a further alternative shown in FIG. 5, a single pour spout 334 may span and receive fluid from the two passages 322, 324 of a closure device 300 which, apart from the details of the single pour spout 334, may be the structural and functional equivalent of the closure device 100 of FIG. 1.

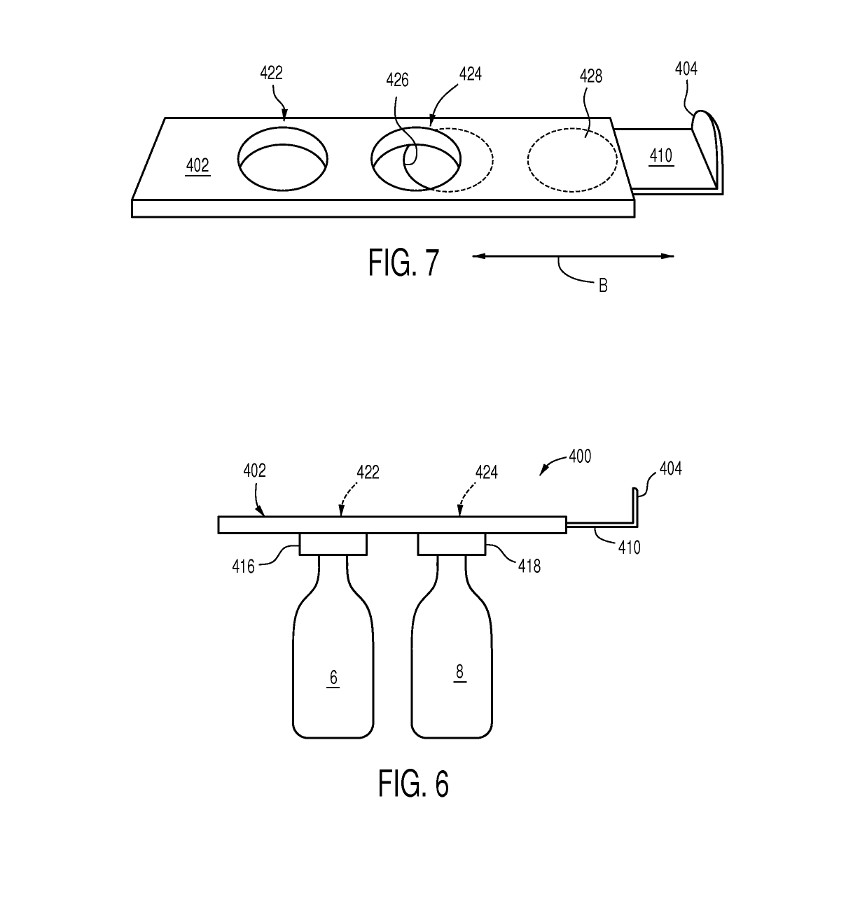

Thus far, the invention has been described in terms of rotary valve operation. It will be appreciated that other arrangements are possible. For example, a valve assembly may be linearly movable, as seen in FIGS. 6 and 7. A closure device 400 is seen to engage two fluid containers 6, 8 and to enable one passage 422, a second passage 424, or both passages 422, 424 simultaneously to be opened to flow.

The closure device 400 may comprise a housing 402 having an internal channel (not shown) which receives a linearly movable slide valve 410 to be received in close cooperation therewithin such that the valve 410 may be slid linearly along the length of the housing 402. The direction of slide of the valve 410 is indicated by an arrow B in FIG. 7. The valve 410 may comprise a valve operator in the form of a tab 404 which may be grasped by finger when sliding the valve 410 to its various operative positions.

As shown in FIG. 7, the valve 410 has been moved to a position wherein an opening 426 formed in the valve 410 is in partial alignment with a fluid passage 424 formed in the housing 402. It will be seen from FIG. 6 that the fluid passage 422 is in alignment with a socket 416 which may engage and retain the fluid container 6 in the same way as that of the socket 116 of FIG. 2. Similarly, a socket 418 may engage and retain the fluid container 8 in the same way as that of the socket 118. Hence in the example of FIG. 7, flow from the fluid container 8 may occur. The degree of opening of the fluid passage 424 may be adjusted by adjusting the position of the valve 410 along the housing 402.

The housing 402 is sufficiently long as to enable the valve 410 to be moved such that the opening 426 may be aligned with the fluid passage 424 of the housing 402, and also so that the opening 428 may be aligned with the fluid passage 422, or such that the openings 426, 428 may be simultaneously aligned with the fluid passages 422, 424 to enable simultaneous opening of and flow from both fluid containers 6 and 8.

The closure devices 100 and 400 may be utilized both with separate fluid containers such as the fluid containers 6 and 8, or alternatively, with a single fluid container divided into dual compartments. FIG. 8 shows how the closure device 100 may be utilized with a dual compartment container 60 having a first compartment 62 and a second compartment 64 separated by an internal wall 66. Apart from connection in common of the first compartment 62 and the second compartment 64, the dual compartment container may have pour orifices which are structural and functional equivalents of the pour orifices 2, 4. Therefore, the invention may be thought of as a dual compartment container such as the dual compartment container 60 and a closure device such as the closure devices 100 or 400 for controlling a plurality of pour orifices of the dual compartment container. Obviously, the closure devices 100 and 400 may be provided with any of the pour spout arrangements shown in FIGS. 1, 4, and 5 when utilized with separate fluid containers such as the fluid containers 6 and 8, or with a dual compartment container such as the dual compartment container 60.

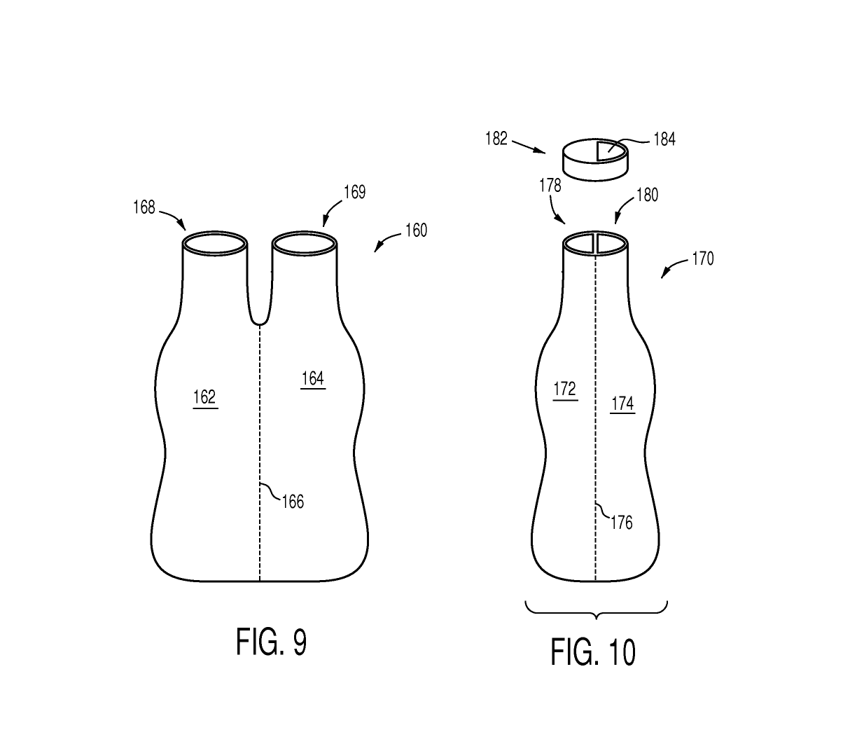

FIG. 9 shows a variation on the dual compartment container of FIG. 8. Notably, a dual compartment container 160 may have a first compartment 162 and a second compartment 164 separated by a common internal wall 166. Each compartment 162, 164 may have a respective pour orifice 168 or 169. The pour orifices 168, 170 are separate from one another, and can be closed by separate caps or by a common cap having accommodation of two spaced apart pour orifices (neither cap arrangement is shown).

FIG. 10 shows a further variation wherein a dual compartment container 170 has a first compartment 172 and a second compartment 174 separated by a common internal wall 176. Respective pour spouts 178, 180 of the first and second compartments 172, 174 are siamesed along their full extent by the common internal wall 176. The pour spouts 178, 180 could be closed by a common cap 182. The cap 182 could be rotatable about the pour spouts 178,180 so as to vary the proportion of the cross sectional area of an outlet opening 184 of the cap 182 which is exposed to each of the pour spouts 178, 180.

The dual compartment containers 160 and 170 both enables the user to vary the proportion of two fluids being poured simultaneously from the respective dual compartment containers 160 or 170 at his or her discretion. The invention may therefore be thought of as a method of dispensing a fluid having two discrete fluid components, one stored within each of the compartments of the dual compartment container, or as a method of controlling constituency of the mixed fluids. Controlling constituency would of course include the step of adjusting a cap so as to establish desired proportions of the two fluids. The novel apparatus enables this proportioning to be accomplished while still requiring fluid containers which bear characteristics of ordinary consumer receptacles. Moreover, the method may be thought of in terms of storing two fluids separately and subsequently selectively dispensing one fluid or two fluids in predetermined ratio.

The invention may also be thought of as an assembly of a plurality of fluid containers in combination with a closure device for holding the plurality of fluid containers together and controlling the pour orifices of the fluid containers. The combination may comprise for example either of the closure devices 100 or 400, together with fluid containers such as the fluid containers 6 and 8.

The present invention has been described in terms of one closure device such as the closure devices 100 and 400, operating in conjunction with two fluid containers such as the fluid containers 6 and 8. It would be possible to modify a closure device of the present invention to accommodate working with more than two fluid containers (this option is not shown). For example, a closure device could be increased in dimensions and provided with additional sockets such as the sockets 116 and 118, and with additional passages such as the passages 122 and 124. The valve of a closure device could be provided with only two openings such as the openings 126 and 128, or may have a number of openings equal to the number of passages of its associated housing.

The present invention is susceptible to other modifications and variations which may be introduced thereto without departing from the inventive concepts. For example, sizes of the various valve openings may be varied so as to be unequal, to enable that fluids be poured in ratios other than one-to-one.

In addition, configuration of the housing, such as the housing 102, may depart from the circular and straight designs shown and described herein. A housing may be arcuate, with the valve being operated by a tab to move arcuately rather than linearly, for example.

Also, while the fluid containers have been depicted as glass bottles, the invention contemplates other types of containers. For example, containers may be fabricated from metal, plastic, waxed paper, and others. Pour orifices formed in containers may project in directions other than straight along the axis of the container. For example, many waxed paper containers have integrated plastic pour orifices disposed on an inclined upper panel of the container. The present invention may be adapted to work with any of these types of containers.

While the present invention has been described in connection with what is considered the most practical and preferred embodiment, it is to be understood that the present invention is not to be limited to the disclosed arrangements, but is intended to cover various arrangements which are included within the spirit and scope of the broadest possible interpretation of the appended claims so as to encompass all modifications and equivalent arrangements which are possible

I claim:

1. A closure device for controlling a plurality of pour orifices of at least one fluid container, comprising a housing disposed to span, yoke together, and selectively close and open at least two pour orifices of at least one fluid container, wherein the housing has a first engagement structure disposed to engage and hold one pour orifice, a second engagement structure disposed to engage and hold a second pour orifice, and a valve assembly disposed to open and close each of the pour orifices selectively individually and collectively.

2. The closure device of claim 1, wherein the valve assembly comprises a rotary valve secured to the housing.

3. The closure device of claim 1, wherein the valve assembly comprises a linearly movable slide valve secured to the housing.

3. The closure device of claim 1, wherein the valve assembly comprises a valve operator which is accessible for manual manipulation from outside the housing.

4. The closure device of claim 1, wherein the housing comprises a first fluid passage for enabling pouring from one of the at least two pour orifices and a second passage for enabling pouring from another of the at least two pour orifices, and the valve assembly is disposed to selectively open the first passage or the second passage or both the first passage and the second passage.

5. The closure device of claim 4, wherein the housing comprises a first pour spout disposed to direct fluid being poured from the first pour orifice and a second pour spout disposed to direct fluid being poured from the second pour orifice.

6. The closure device of claim 4, wherein the housing comprises a pour spout disposed to span and receive fluid from both the first pour orifice and the second pour orifice.

7. A dual compartment container and a closure device for controlling a plurality of pour orifices of the dual compartment container, comprising:
a container having at least a first fluid storing compartment comprising a first pour orifice and a second fluid storing compartment comprising a second pour orifice; and
a housing disposed to span, yoke together, and selectively close and open the first pour orifice and the second pour orifice, wherein the housing comprises a valve assembly disposed to open and close the first pour orifice and the second pour orifice selectively individually and collectively.

8. The closure device of claim 7, wherein the valve assembly comprises a rotary valve secured to the housing.

9. The closure device of claim 7, wherein the valve assembly comprises a linearly movable slide valve secured to the housing.

10. The closure device of claim 7, wherein the valve assembly comprises a valve operator which is accessible for manual manipulation from outside the housing.

11. The closure device of claim 7, wherein the housing comprises a first fluid passage for enabling pouring from one of the at least two pour orifices and a second passage for enabling pouring from another of the at least two pour orifices, and the valve assembly is disposed to selectively open the first passage, the second passage, and both the first passage and the second passage.

12. The closure device of claim 11, wherein the housing comprises a first pour spout disposed to direct fluid being poured from the first pour orifice and a second pour spout disposed to direct fluid being poured from the second pour orifice.

13. The closure device of claim 11, wherein the housing comprises a pour spout disposed to span and receive fluid from both the first pour orifice and the second pour orifice.

14. A combination comprising a plurality of fluid containers and a closure device for holding the plurality of fluid containers together and controlling the pour orifices of the fluid containers, comprising:
a first container having a first fluid storing compartment and a first pour orifice;
at least a separate second container having a second fluid storing compartment and a second pour orifice; and
a housing disposed to span, yoke together, and selectively close and open the first pour orifice and the second pour orifice while securing the first container and the at least second container together, wherein the housing comprises a valve assembly disposed to open and close the first pour orifice and the second pour orifice selectively individually and collectively.

15. The combination of claim 14, wherein the valve assembly comprises a rotary valve secured to the housing.

16. The combination of claim 14, wherein the valve assembly comprises a linearly movable slide valve secured to the housing.

17. The combination of claim 14, wherein the valve assembly comprises a valve operator which is accessible for manual manipulation from outside the housing.

18. The combination of claim 14, wherein the housing comprises a first fluid passage for enabling pouring from one of the at least two pour orifices and a second passage for enabling pouring from another of the at least two pour orifices, and the valve assembly is disposed to selectively open the first passage or the second passage or both the first passage and the second passage.

19. The combination of claim 18, wherein the housing comprises a first pour spout disposed to direct fluid being poured from the first pour orifice and a second pour spout disposed to direct fluid being poured from the second pour orifice.

20. The combination of claim 18, wherein the housing comprises a pour spout disposed to span and receive fluid from both the first pour orifice and the second pour orifice.
